(19) United States
(12) Patent Application Publication
(10) Pub. No.: US 2006/0007709 A1
(43) Pub. Date: Jan. 12, 2006

(54) LED sensor night light

(76) Inventor: Se Kit Yuen, Hong Kong (CN)

Correspondence Address: ARTHUR KING MA, 1030 CORONADO DRIVE, ARCADIA, CA, 91007, US

(21) Appl. No.: 10/964,374

(22) Filed: Oct. 12, 2004

(30) Foreign Application Priority Data
Jul. 6, 2004 (HK) 04104876.7

(51) Int. Cl. H01R 33/00

(52) U.S. Cl. 362/641; 362/642

(57) ABSTRACT

A LED sensor night light comprises a housing consists of a front panel and a back panel, a transparent front protective shade with refractive angels at its surface; and a semi transparent back protective shade, and at least one cold-cathode light source as a illuminant is affixed in between said front panel and said back panel, and a plurality of circuit boards with at least one sensor circuitry, at least one fluorescent optic integrating pillar is attached in the center portion of said circuit board and placed to cover said light source, and a plurality of metal power plug, and at least one light-reflecting mirror in an arch shape with multiple reflecting angels which provide a night light night light with two positions of illumination, a mean of automate mechanism which allows night light to turn on and on automatically as needed and mean of balancing and converging said cold-cathode light source into a light sphere to relatively increase a lighting power with the same given power supply and light source.

### BACKGROUND OF THE PRESENT INVENTION

1. Field of Invention

The present invention is relates to a night light and more particularly to a LED sensor night light.

2. Description of Related Arts

Conventional night lights generally providing two types light emitting, i.e. scatted, and diffused pattern of light or a narrow beam of light. People use a night light that emits a narrow beam when illuminate a relatively small surface directly in front of a lens such as a wall or step. Meanwhile, when use in a large area such as hallway, bedroom and restroom, a night light that emits a scattered, diffused pattern light will be employed.

One disadvantage for most convention night lights is that many night lights use incandescent or fluorescent bulbs with relatively short life spans. Some manufacturers take advantage of a relatively short life span of bulbs by marketing night lights with non-replaceable bulbs so that the entire night light must be replaced as soon as the bulb burns out. It is not environmental friendly at all. Yet, it ultimately becomes costly for both the earth and the consumers.

Another disadvantage is that most conventional night lights provide only one position of illumination, normally at an outer surface but not at the surface which is against the wall outlet.

Another disadvantage is that most conventional night lights use incandescent or fluorescent bulbs which become very hot at its surface after an extended period time of usage. Elderly seniors and children might accidental have contact with those bulbs and result injuries.

Another disadvantage is that most conventional night lights do not provide any means of automates mechanism which allows night light to turn on and off automatically as needed.

### SUMMARY OF THE PRESENT INVENTION

A main object of the present invention is to provide a LED sensor night light having an ability to focus all angles of lights in form of an optical sphere emitting a more powerful light with the same amount of power supply.

Another object of the present invention is to provide a LED sensor night light which is environmental friendly with a long life span.

Another object of the present invention is to provide a LED sensor night light with two positions of illumination.

Another object of the present invention is to provide a LED sensor night light with a mean of automate mechanism which allows night light to turn on and on automatically as needed.

Another object of the present invention is to provide a LED sensor night light with a surface will not hot even after an extended period time of usage

Accordingly, in order to accomplish the above objects, the present invention provides a LED sensor night light, which comprises:
a housing consists of a front panel and a back panel,
a transparent front protective shade with refractive angels at its surface; and a semi-transparent back protective shade, and
at least one cold-cathode light source as a illuminant is affixed in between said front panel and said back panel, and
a plurality of circuit boards with at least one sensor circuitry,
at least one fluorescent optic integrating pillar is attached in the center portion of said circuit board and placed to cover said light source, and
a plurality of metal power plug, and
at least one light-reflecting mirror in an arch shape with multiple reflecting angels.

### BRIEF DESCRIPTION OF THE DRAWINGS

FIG. 1 is a side view of the present invention. A soft light was emitted through the semi-transparent light shade at position one is illustrated.

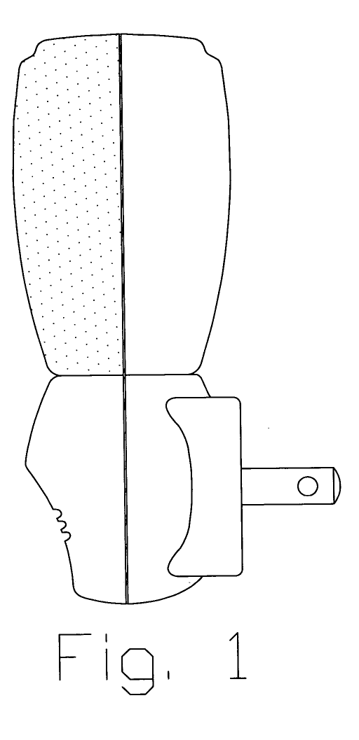

FIG. 2 is a side view of the present invention. A soft light was emitted through the semi-transparent light shade at position two is illustrated.

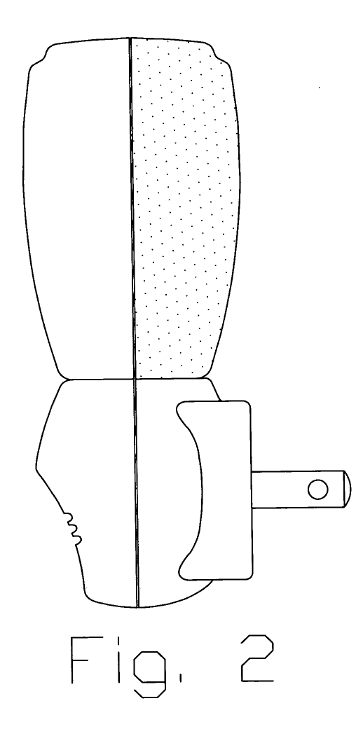

FIG. 3 is a vertical sectional view thereof;

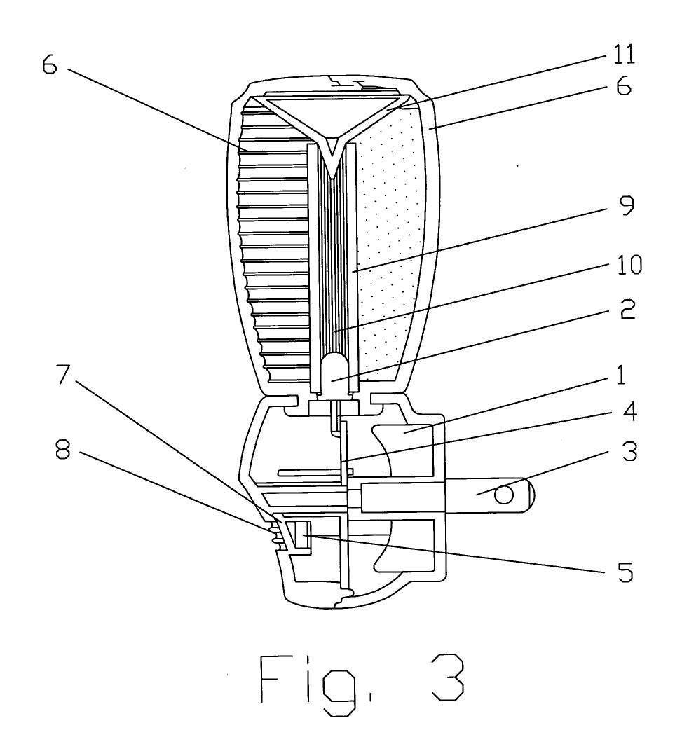

FIG. 4 is a bottom view thereof;

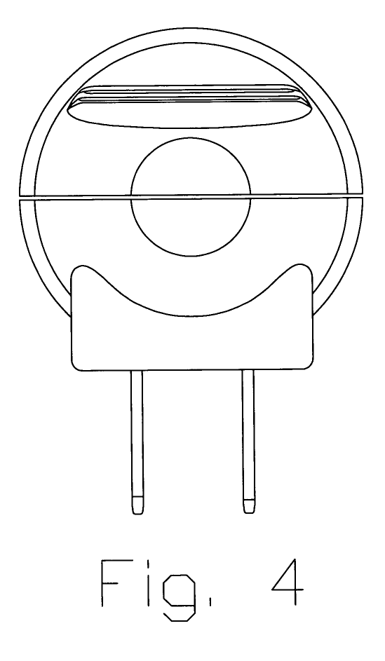

FIG. 5 is a top view thereof;

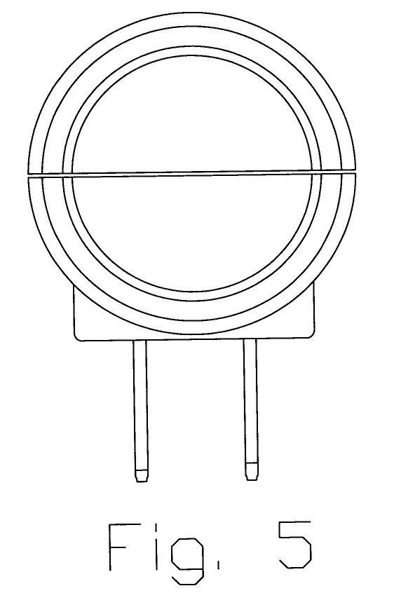

FIG. 6 is a front view thereof;

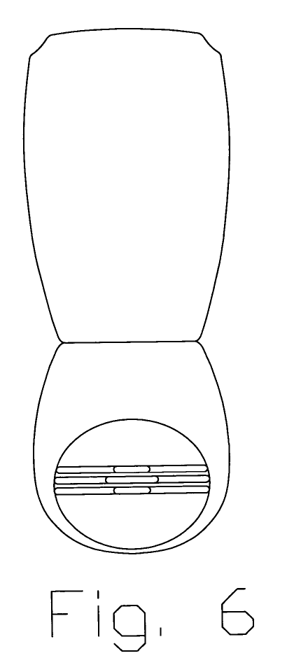

FIG. 7 is a rear View thereof;

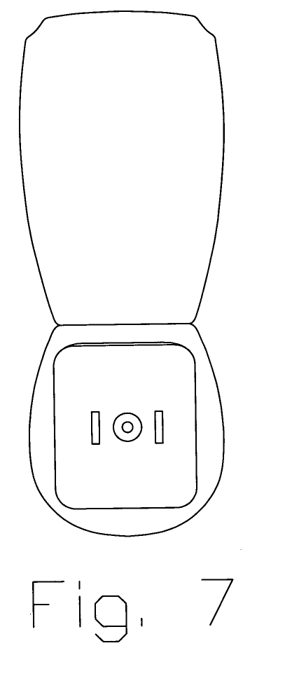

FIG. 8 is another side view thereof;

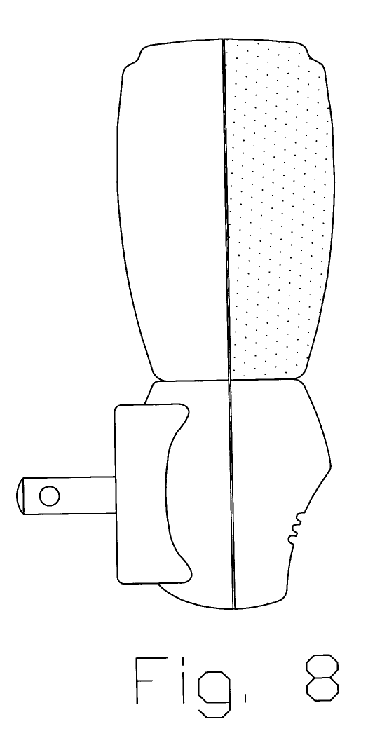

FIG. 9 is a perspective sectional view of the present invention.

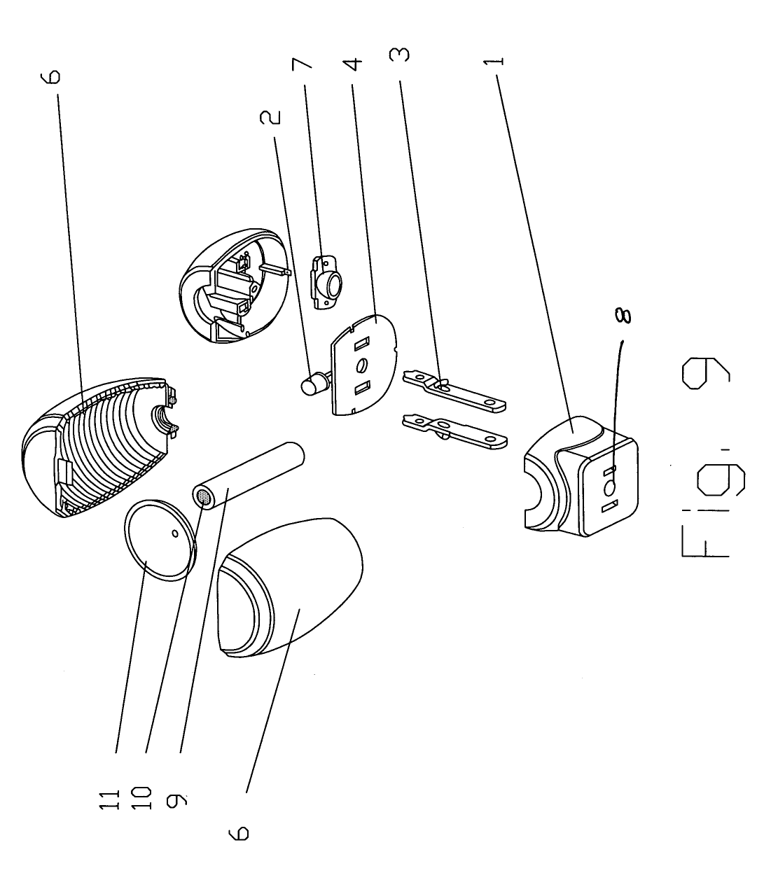

### DETAILED DESCRIPTION OF THE PREFERRED EMBODIMENT

The present invention comprises of an illuminant (1) which is usually a cylinder-shaped structure. Inside the illuminant, there are at least one cold-cathode super-light source (2) and two metal power plugs (3). Said metal power plugs (3) are fastened to a circuit board (4) on one side. Said circuit board (4) further comprise of at least one sensor circuitry (5), in front of said circuit board (4) there is a transparent front protective shade and a semi-transparent back protective shade (7), which is closely mounted to a transmitting hole (8) in the front of said illuminant (1). Said metal power plugs (3) are plugged into a power socket to obtain power for said circuit board (4) of said illuminant (1). At daytime, natural light goes through said transmitting hole (8) of said illuminant (1) to reach said sensor circuitry (5), which then turns off said cold-cathode light source (2) automatically. In another word, at night, said sensor circuitry (5) senses no natural light, and it will then automatically turn on said cold-cathode light source (2).

Said cold-cathode light source (2) is affixed at top of portion of said illuminant (1). A luminous end of said cold-cathode light source (2) lies inside a chamber (10) of said fluorescent optic integrating pillar (9), another end of said cold-cathode light source (2) has at least one light-reflecting mirror in an arch shape with multiple reflecting angels (11). Said light-reflecting mirror (11) is affixed on top of a transparent front protective shade with refractive angels at its surface; and a semi-transparent back protective shade (6). Bottom portion of said shade (6) is flexibly connected to top portion of said illuminant (1). Said transparent front protective shade with refractive angels at its surface, and a semi-transparent back protective shade (6)

Said cold-cathode light source provide an ability to form light pillar through a fluorescent and semi-transparent optic integrating pillar. The end of the light pillar has an arc light-reflecting mirror, which balancing and converging said cold-cathode light source into a light sphere. Due to the precision structure of the said fluorescent semi-transparent optic integrating pillar and the light-reflecting mirror, the light source can be enhanced and converged into a lighting sphere. The controllable source is thus converged into a mass of light, like a strong light sphere thereby relatively increase a lighting power with the same given power supply and light source.

The present invention is an environmental friendly, energy-saving, safe and non-heat-remitting light. It is especially suitable for domestic use without worrying little children might be burned from touching it. At night, it provides sufficient lighting for seniors, children and adults to walk around in the house, climbing up or down the stairs.

What is claimed is:

1. LED sensor night light, which comprises:
a housing consists of a front panel and a back panel,
a housing consists of a front panel and a back panel,
a transparent front protective shade with refractive angels at its surface; and a semi-transparent back protective shade, and
a cylinder type fluorescent optic integrating pillar having a chamber with a predetermined size and shape vertically placed in between said front panel, said back panel, said transparent front protective shade and said semi-transparent back protective shade, and
at least one cold-cathode light source as a illuminant is affixed in between said front panel and said back panel and lies inside a chamber said fluorescent optic integrating pillar, and
a plurality of circuit boards with at least one sensor circuitry,
at least one fluorescent optic integrating pillar is attached in the center portion of said circuit board and placed to cover said light source, and
a plurality of metal power plug, and
at least one light-reflecting mirror in an arch shape with multiple reflecting angels.

2. LED sensor night light as recited in claim 1, wherein said circuit board further comprises:
at least one sensor circuitry, in front of said circuit board; and
at least one transmitting hole in front of said illuminant, and
a plurality of metal power plugs are plugged into a power socket to obtain power for said circuit board thereby.
At daytime, natural light goes through said transmitting hole of said illuminant to reach said sensor circuitry, which then turns off said cold-cathode light source automatically. In another word, at night, said sensor circuitry senses no natural light, and it will then automatically turn on said cold-cathode light source.

3. A LED sensor night light as recited in claim 1, wherein said housing is comprises of:
a front panel with a transmitting hole centrally located and a back panel are mounted together correspondingly at a lower portion of said housing, and
a transparent front protective shade with refractive angels at its surface; and a semi-transparent back protective shade are attached perpendicularly above said front and back penal,

4. A LED sensor night light as recited in claim 1, wherein said fluorescent optic integrating pillar provide an ability to change a predetermined colors of light emitted by said cold-cathode light source.

5. A LED sensor night light as recited in claim 1, wherein said cold-cathode light source does not emit any heat thereby.

6. A circuit board for LED sensor night light, comprises:
at least one sensor circuitry, in front of said circuit board; and
at least one transmitting hole in front of said illuminant, and
a plurality of metal power plugs are plugged into a power socket to obtain power for said circuit board thereby.
At daytime, natural light goes through said transmitting hole of said illuminant to reach said sensor circuitry, which then turns off said cold-cathode light source automatically. In another word, at night, said sensor circuitry senses no natural light, and it will then automatically turn on said cold-cathode light source.

7. LED sensor night light, which comprises:
a housing consists of a front panel and a back panel,
a transparent front protective shade with refractive angels at its surface; and a semi-transparent back protective shade, and
a cylinder type fluorescent optic integrating pillar having a chamber with a predetermined size and shape vertically placed in between said front panel, said back panel, said transparent front protective shade and said semi-transparent back protective shade, and
at least one cold-cathode light source as a illuminant is affixed in between said front panel and said back panel and lies inside a chamber said fluorescent optic integrating pillar, and
a plurality of circuit boards with at least one sensor circuitry,
at least one fluorescent optic integrating pillar is attached in the center portion of said circuit board and placed to cover said light source, and
a plurality of metal power plug, and
at least one light-reflecting mirror in an arch shape with multiple reflecting angels.
Wherein said circuit board further comprises:
at least one sensor circuitry, in front of said circuit board; and
at least one transmitting hole in front of said illuminant, and
a plurality of metal power plugs are plugged into a power socket to obtain power for said circuit board thereby.
At daytime, natural light goes through said transmitting hole of said illuminant to reach said sensor circuitry, which then turns off said cold-cathode light source automatically. In another word, at night, said sensor circuitry senses no natural light, and it will then automatically turn on said cold-cathode light

8. A LED sensor night light as recited in claim 7, wherein said housing is comprises of:
a front panel with a transmitting hole centrally located and a back panel are mounted together correspondingly at a lower portion of said housing, and
a transparent front protective shade with refractive angels at its surface; and a semi-transparent back protective shade are attached perpendicularly above said front and back penal,

9. A LED sensor night light as recited in claim 7, wherein said fluorescent optic integrating pillar provide an ability to change a predetermined colors of light emitted by said cold-cathode light source.

10. A LED sensor night light as recited in claim 7, wherein said cold-cathode light source does not emit any heat thereby.

11. A LED sensor night light as recited in claim 1, wherein said shade can move relatively between position one and position two, providing the user with soft light in position one and strong light at position two.

12. A LED sensor night light as recited in claim 7, wherein said shade can move relatively between position one and position two, providing the user with soft light in position one and strong light at position two.

13. A LED sensor night light as recited in claim 1, said light source provide an ability to form a light pillar through a fluorescent and semi-transparent optic integrating pillar. At end portion of said light pillar, there is light-reflecting mirror in an arc shape, which provide mean of balancing and converging said cold-cathode light source into a light sphere thereby relatively increase a lighting power with the same given power supply and light source.

14. A LED sensor night light as recited in claim 7, said light source provide an ability to form a light pillar through a fluorescent and semi-transparent optic integrating pillar. At end portion of said light pillar, there is light-reflecting mirror in an arc shape, which provide mean of balancing and converging said cold-cathode light source into a light sphere thereby relatively increase a lighting power with the same given power supply and light source.
